(19) United States
(12) Patent Application Publication
(10) Pub. No.: US 2017/0246988 A1
(43) Pub. Date: Aug. 31, 2017

(54) VEHICLE DIGITAL MESSAGE DISPLAY

(71) Applicant: Chukwudi IHEDINMAH, Washington, DC (US)

(72) Inventor: Chukwudi IHEDINMAH, Washington, DC (US)

(21) Appl. No.: 15/508,238

(22) PCT Filed: Dec. 1, 2015
(86) PCT No.: PCT/US15/63293

§ 371 Date: Mar. 2, 2017

Related U.S. Application Data
(60) Provisional application No. 62/085,697, filed on Dec. 1, 2014.

(51) Int. Cl. B60Q 1/50

(52) U.S. Cl. CPC B60Q 1/503

(57) ABSTRACT

A motor vehicle alerting bright light dimming message display system for requesting a driver of a vehicle behind the vehicle displaying the message to dim his bright lights. The message display system improves vehicle safety and promotes driver courtesy. The message display system may include an LED or LCD display at the rear of a vehicle and a control circuit for operating the display. In one aspect of the invention, the display is automatically activated by a bright light from a trailing vehicle. The digital message display for vehicles detects a bright light intensity exceeding a threshold and automatically displays a request, directed to the driver of the trailing vehicle, to dim lights. The display may also be configured to display advertising, emergency and other messages.

### TECHNICAL FIELD

The present invention relates to a digital message display for vehicles. In one aspect, it relates to a vehicle digital message display having a sensor to detect use of a high beam headlight by a trailing vehicle, automatically displaying a message to the trailing vehicle to lower the headlight beam if high beam usage is sensed. In another aspect the vehicle digital message display may display other messages, such as advertising.

This invention relates to a vehicle digital message display system and more particularly to a digital message display system which automatically requests drivers of trailing vehicles to dim their headlights.

### BACKGROUND ART

It is, unfortunately, too common for drivers to forget to dim their headlights. Bright light from high beam headlights will reflect off the side view and rear view mirrors of any vehicle directly ahead and into that vehicle's driver's eyes. The reflected lights not only distract and annoy, they impair the leading driver's vision and ability to see the road ahead clearly and control his vehicles accordingly.

A driver affected by reflected glare from high beam headlights has few options. Changing lanes may be an option if another lane is available, but doing so when the driver's vision is impaired by glare can be dangerous when the driver cannot clearly see whether an adjacent lane is occupied by another vehicle. Alternatively, the driver can signal the driver of a rear vehicle that his headlights are configured for high beam by quickly turning her vehicle's lights on and off. This gesture, however, may not be understood and, moreover, is extremely dangerous when driving on highways and freeways at night at high speeds. Worse yet, the danger is increased during periods of rain and snow because of reduced visibility, increased glare and a decrease in tire traction.

To help alleviate some of the problem of glare from undesirable use of high beam headlights, automobile manufacturers have equipped vehicles with “day and night” rear view mirrors. The use of these rear view mirrors angled for “night” use reduces glare from bright headlights, but at the expense of decreasing the visibility of objects seen in the “night” mirror's reflection. Side view mirrors still affect drivers' eyes because most vehicle manufacturers do not include side view mirrors with “day and night” configurations. Consequently, any side view mirror adjustment to reduce high beam headlight glare will lead to limited perspectives of the driver's surroundings and may contribute to dangerous accidents.

With all of the above steps, the driver of the leading vehicle not only has impaired vision, but is distracted trying to remedy the situation.

Thus, a device that assists with remedying the high beam glare problem, not requiring the intervention of the potentially glare-impaired driver, and providing unambiguous information to the high beam driver, is desired.

U.S. Pat. No. 5,113,175, issued on May 12, 1992 to R. Addell, discloses an automated motor vehicle bright light dimming signal for alerting a driver of a vehicle, which is behind a signaling vehicle, to dim her high beam headlights. Addell teaches a bright light dimming signal consisting of a green, blue, etc. light with a rapid flash rate. This non-verbal signal, however, is ambiguous to the intended driver and may be confused with flashing lights from emergency or law enforcement vehicles. The flashing colored light signal, moreover, is not commonly recognized as a request to dim one's lights.

U.S. Pat. No. 6,300,870, issued on Oct. 9, 2001 to W. Nelson, discusses use of an automotive digital rear window display. Nelson teaches, however, that the texts are intended for use as adjuncts to conventional vehicle brake lights or turn signals. Nelson does not teach or suggest either detecting lights of high beam intensity or communicating to a driver that he should dim such lights.

U.S. Pat. No. 7,378,948, issued on May 27, 2008 to E. Somuah, discloses a vehicle that detects a tailgater and automatically flashes a warning message on a rearward facing digital message display in view of trailing traffic. Somuah does not teach or suggest either detecting lights of high beam intensity or communicating to a driver that she should dim such lights.

None of the above inventions and patents, taken either singly or in combination, is seen to describe the instant invention as claimed or solve the identified problems.

### DISCLOSURE OF THE INVENTION

Accordingly, the limitations and problems as just described are obviated according to embodiments of the present invention which include a digital message display, to be mounted on the rear of an automobile, capable of displaying a pre-defined message. Light sensor(s) are mounted on the vehicle's rear to detect bright light intensity. A microcontroller unit is electrically connected to the display and sensors and will cause the pre-determined message to be displayed when a light intensity exceeding a threshold is detected. The message to the driver of the trailing vehicle with lights configured for high beam requests him to “DIM LIGHTS PLEASE.” This communication, which is automatically issued when lights of high beam intensity are detected, enhances driver safety and helps to prevent accidents. A proximity sensor may be used in conjunction with the light sensor to determine activation of the message.

In one embodiment, there is provided a system in a motor vehicle for requesting a driver of a vehicle behind to dim his bright headlights. The system has at least one digital message display mounted on the rear of a vehicle, the digital message display being adapted to display a digital message for requesting a driver who is operating the vehicle behind the requesting vehicle to dim his vehicle's bright headlights and a power supply for supplying electrical power to said digital message display. The system may have an automatic control system which is responsive to lights of high beam intensity from a vehicle behind the requesting vehicle. The automatic control system may have a photodiode unit which is responsive to lights of high beam intensity from a vehicle behind the requesting vehicle.

In another embodiment, there is provided a digital message display system for vehicles having a message display capable of displaying short textual messages, the message display being adapted for mounting in or on a first vehicle and thereby being viewable by a second vehicle behind. The system may have a bright light sensor(s) adapted for mounting in or on the first vehicle and thereby being subject to bright light incidence of the second vehicle. The system may further include a microcontroller connected to the message display and the bright light sensor(s). The system may also include non-transitory computer readable media accessible to the microcontroller, the media storing microcontroller program instructions for determining bright light incidence on the bright light sensor(s) and instructions for selectively displaying on the message display a predefined short textual message in response to the determination.

The digital message display may comprise light emitting diodes or liquid crystals which may be arranged in a matrix. The message may include a request for the trailing driver to lower high beams.

In some embodiments, the bright light sensor is at the end of a tube. The tube may have a non-reflective interior surface. The tube may have a filter, a light control film, or a shader in the tube between the sensor and the aperture exposed to potential bright light incident beams.

In some embodiments, the system further includes a proximity detector. The microcontroller program instructions for determining bright light incidence further comprise instructions to determine a distance of the second vehicle from the first vehicle. If the distance is outside a set range, a determination of bright light incidence will be inhibited.

In some embodiments, the invention comprises a motor vehicle having the display system.

The foregoing features, benefits and advantages, together with additional features, benefits and advantages, will become apparent from the ensuing detailed description of multiple embodiments and the accompanying drawings. The best mode contemplated in practicing the invention is disclosed and the subject matter in which exclusive property rights may be claimed is set forth in each of the numbered embodiments at the conclusion of the detailed description.

### BRIEF DESCRIPTION OF DRAWINGS

For a comprehensive exposure of the features, nature and advantageous effects of the present invention, reference is now made to the detailed description in conjunction with the associated drawings, in which:

FIG. 1 is an exemplary illustration of an environmental, perspective view of an automobile with high beams trailing an automobile having a digital message display according to an aspect of the present invention.

FIGS. 2 and 3 illustrate exemplary locations for a digital message display on the rear of an automobile according to aspects of the present invention.

FIG. 4 is an exemplary illustration of a perspective view of a display and sensing unit according to an aspect of the present invention.

FIG. 5 is an exemplary illustration of a perspective and partial cutaway view of a sensing unit portion according to an aspect of the present invention.

FIG. 6 illustrates an exemplary block diagram according to an aspect of the present invention.

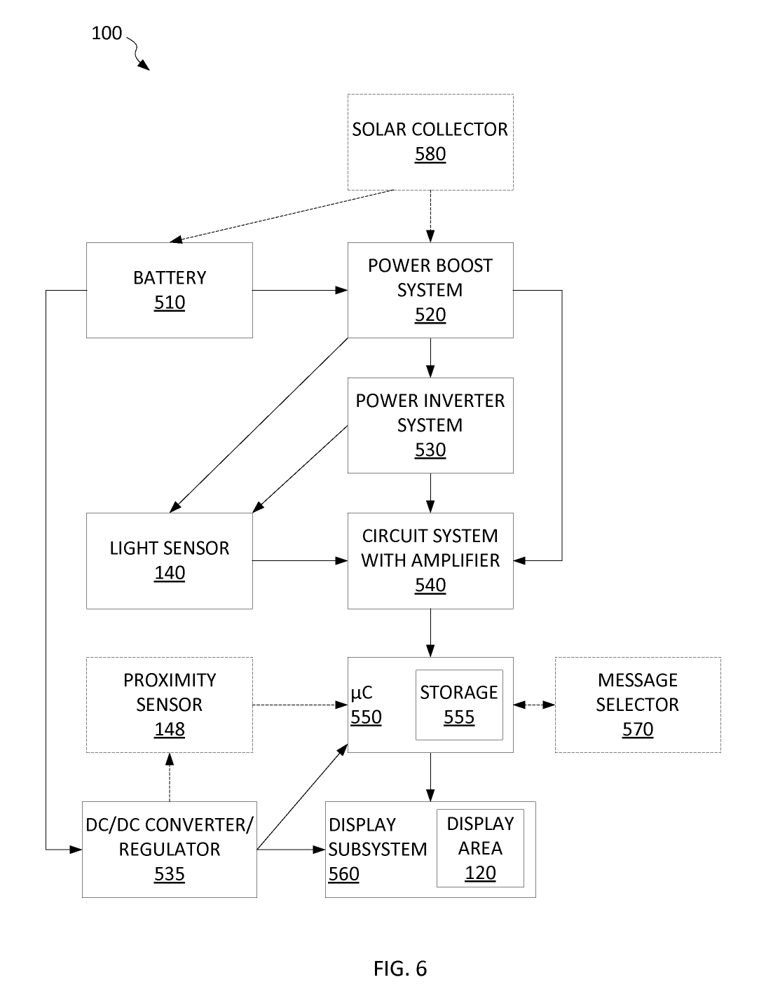

### DESCRIPTION OF EMBODIMENTS

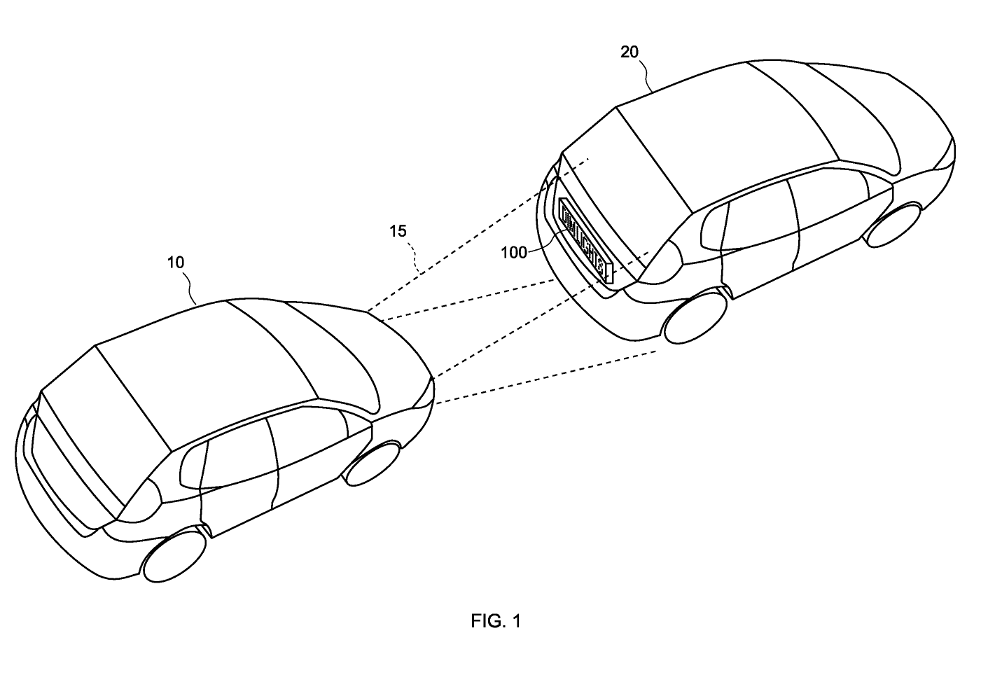

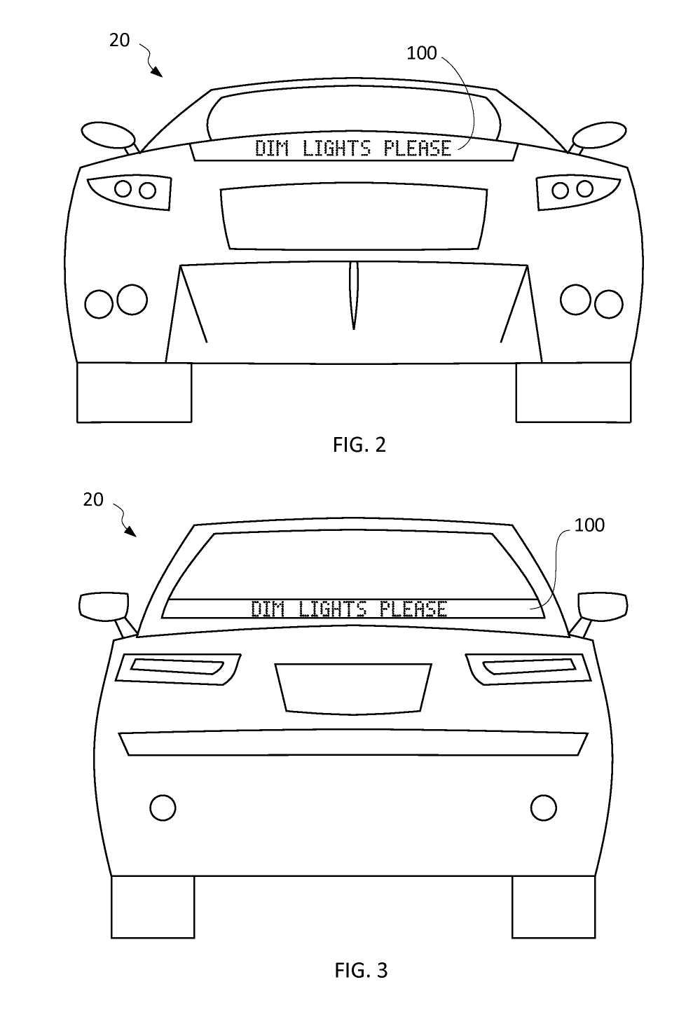

With respect to FIG. 1, according to one aspect of the present invention, a digital message display 100, mountable on a vehicle 20, is provided. In one aspect, digital message display 100 may display a message such as “DIM LIGHTS” when a following vehicle, such as vehicle 10, is employing its high beam headlights. When high beam light 15 of trailing vehicle 10 is incident on display 100, it senses such incident light and automatically displays the desired message. Digital message display 100 may be configured to be mounted onto the rear of a vehicle 20 so that it is in the sight line of a driver of following vehicles such as vehicle 10. With reference to FIG. 2, digital message display 100 may be integral to the rear body, trunk lid or spoiler of vehicle 20. With reference to FIG. 3, digital message display 100 may be disposed inside vehicle 20, viewable through the rear window or rear windscreen. In alternate embodiments, not shown, digital message display 100 may be disposed within a tail light assembly.

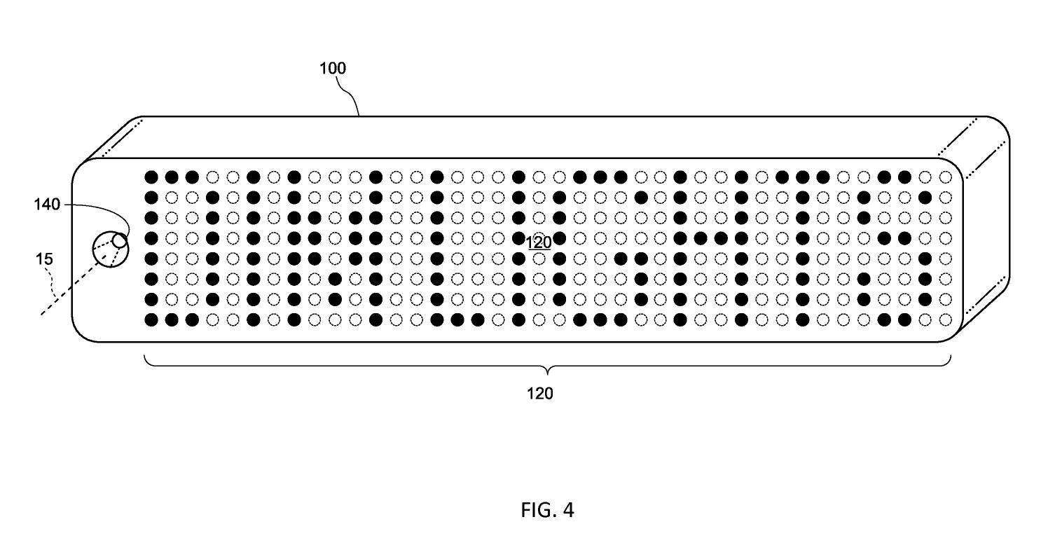

Referring now to FIG. 4, message display 100 includes a message display area 120 and sensor 140. According to one embodiment, message display area 120 comprises a matrix of elements capable of switching their optical state. For example, message display area 120 may comprise a matrix of light emitting elements such as light emitting diodes (LEDs), organic light emitting diodes (OLEDs), plasma elements, electroluminescent elements, cold cathode fluorescent (CCFL) or incandescent light bulbs. In another embodiment, message display area 120 may comprise a matrix of reflective elements such as liquid crystal display elements, electrophoretic elements, or mechanically flipped panels (e.g., flip disc, flip dot or vane), optionally including a front- or back-light. In one embodiment the display area 120 may comprise a number of multi-segment elements such as 7-, 9-, 14- or 16-segment modules.

Message display 100 also includes a sensor 140. Sensor 140 is disposed and arranged to be sensitive to illumination having an angle of incidence generally perpendicular to message display 100. In this arrangement, sensor 140 is responsive to direct illumination from a following vehicle's high beam headlights, but not responsive to low beam headlights or incident light from an angle off-perpendicular.

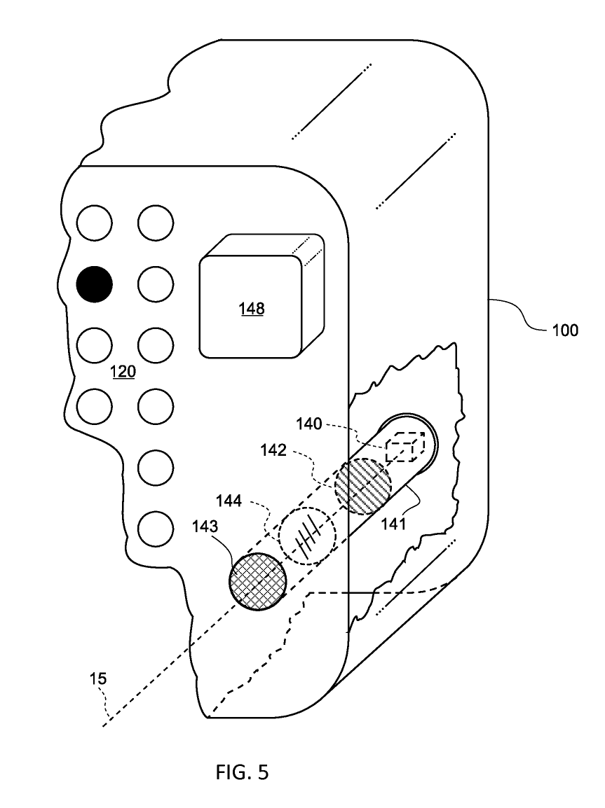

With reference to FIG. 5, in some embodiments, sensor 140 may be disposed at one end of a tube 141 having an aperture at the opposite end. Tube 141 is arranged in display unit 100 such that its longitudinal axis is parallel with the expected beam of incidence of high beam light 15 to lessen the likelihood that ambient or unwanted light will reach the sensor. Tube 141 may include a light filter 144, a shader 143, and/or an advanced light control film 142 which can operate to reduce transmittance of unwanted light and allow for more selective sensing of higher energy high beam light. Filter 144 may be an optical filter selective to desirable wavelengths of light. Shader 143 may be a fabric material woven in a mesh gauze-like manner which breaks the beam of light and absorbs some of the light energy. Advanced light control film 142 may comprise a microlouver film which can operate to control light distributions and reflections. While FIG. 5 depicts tube 141 having all of light filter 144, shader 143 and advanced light control film 142, in some embodiments the tube 141 may have only one of these and, in those embodiments having two or all, they may be arranged in a different sequence.

In some embodiments, a proximity sensor 148 may be operably connected to, or integral with, the display unit 100 such that the proximity of a trailing vehicle 10 to vehicle 20 can be detected. Proximity sensor 148 may comprise an ultrasonic proximity detection unit. Such units may include an emitter and transducer. Proximity sensor 148 may alternatively comprise a radar-based proximity detection unit. Such units may include a radio frequency emitter and receiver. Proximity sensor 148 may alternatively comprise an optical range finding unit. In embodiments with optional proximity sensor 148, a message can be triggered when high beam are detected by sensor 140 and a vehicle 10 is detected within a set range to vehicle 20.

In one embodiment, message display 100 includes a mounting apparatus whereby it may be mounted with a suction cup mounting bracket and a hook and loop (e.g., Velcro®) belt (not shown). The device may be mounted on the suction cup platform with a screw; the platform may include a Velcro belt long enough to go around the trunk lid of the vehicle. The entire display may then be suctioned to the back of the vehicle, the Velcro belt being fasten tightly to the vehicle via the trunk. A similar process may be used for trailers except that display 100 would be belted around the back door.

Referring now to FIG. 5, in many embodiments, message display 100 comprises internal circuitry and components and may include battery 510, power boost system 520, power inverter system 530, circuit system/amplifier 540, microcontroller 550 and display subsystem 560. Microcontroller 550 is one of a type well known in the art that contains a memory, program storage means, and interface circuitry. For example, microcontroller 550 may be an 8- or 16-bit PIC microcontroller from Microchip Technology Inc. or an STM microcontroller from STMicroelectronics. Other word sizes and microcontroller architectures may be used as well, such as AVR and ARM. In some embodiments, there may be a DC/DC converter regulator 535 for converting battery level voltage into a voltage suitable for powering display subsystem 560 and the digital components of display 100, including microprocessor 550 and storage 555.

Storage 555 internal to the microcontroller 550 stores a microcontroller program and data. In one embodiment, storage 555 includes microcontroller instructions and data corresponding to the pseudocode found in the Computer Program Pseudocode Listing 1 appended hereto; such pseudocode may be suitable where microcontroller 550 corresponds to a Atmel microcontroller architecture. In another embodiment, the pseudocode corresponding to the microcontroller instructions may be found in Computer Program Pseudocode Listing 2, appended hereto; such pseudocode may be suitable where microcontroller 550 corresponds to an STM architecture. In embodiments incorporating a proximity sensor 148, the microcontroller instructions may include instructions corresponding to the pseudocode in Computer Program Pseudocode Listing 3, appended hereto.

In one embodiment, light sensor 140 is coupled to microcontroller 550 through circuit and amplifier 540. The program monitors the signal therefrom and determines if a high beam light is incident on the sensor 140. This determination may be made algorithmically, such as according to a heuristic such as detection of a sensor signal at or above a given threshold for a pre-determined amount of time (for example, 800 milliseconds). When the algorithmic condition is satisfied, the program activates the display subsystem 560, activating the display area 120 elements to display the desired message, such as “DIM LIGHTS.” If the desired message exceeds display area 120's capacity to display the message at an adequate resolution, the program includes instructions for scrolling the message across display area 120. For example, if the desired message is “PLEASE DIM YOUR HIGH BEAMS” and the display area 120 comprises an 8-row 40-column matrix, the entire message cannot be resolved on display area 120 at the same instant. Thus, the “PLEASE DIM” would be displayed and 200 milliseconds later, for example, the “P” would be scrolled off the left and the “Y” scrolled on the right, making the display 120 read “LEASE DIM Y.” And the remainder of the message would be scrolled in a likewise manner until fully displayed. In some embodiments, a message may rescroll periodically—whether or not too lengthy for display area 120— every 200 milliseconds, for example. In some embodiments, a message may be programmed to flash periodically, every 120 milliseconds, for example.

In an exemplary embodiment, the light sensor 140 is a photocell, a photo resistor or a photodiode. In a preferred embodiment the light sensor 140 is a photodiode. Light sensor 140 may also be any or a combination of photo resistors, phototransistors, photo interrupters, ambient light, IR, UV sensors, or irDA transceivers.

When a high beam is determined no longer to be incident on sensor 140, the display area 120 may be deactivated. This determination may be made algorithmically, such as according to a heuristic such as detection of a sensor signal at or below a given threshold for a pre-determined amount of time (for example, 1,200 milliseconds).

In one embodiment, display 100 includes its own power source, battery 510. In another embodiment, display 100 may be coupled to a power supply of vehicle 20. Optionally, solar collector 580 may supply power to display 100 and/or charge battery 510.

In one embodiment of the invention, other types of messages, such as advertising messages, emergency messages and on delivery messages may be stored in memory 555 and displayed on display area 120. Advertising messages, such as “BUY JOE'S COLA” may be automatically and periodically displayed, optionally cycling through some plurality of advertising messages stored in memory 555. In one embodiment, an advertising message may automatically follow an automated “dim lights” message. Some embodiments may provide for user-selected message display, such as “CALL 911” or “ON DELIVERY” or “CALL 311” or “FLAT TIRE.” The user may select a desired message using optional message selector 570.

It should be emphasized that the above-described embodiments of the present disclosure are merely possible examples of implementations set forth for a clear understanding of the principles of the disclosure. Many variations and modifications may be made to the above-described embodiments without departing substantially from the spirit and principles of the disclosure. All such modifications and variations are intended to be included herein within the scope of this disclosure and protected by any patent issuing hereupon.

COMPUTER PROGRAM PSEUDOCODE LISTING 1

| //Pseudo code for Car Sticker device1 | |
|---|---|
| Define Device1_dot_M = Device1( ); | |
| Start −> pass in the address of select pins | |
| Set dot matrix text size −> true | |
| Set Text wrap −> false | |
| Turn LED ON | |
| Start loop | |
| For(assigned initial integer value; condition; decrement) | |
| { | |
| | Set dot matrix to clear |
| | Set dot matrix cursor |
| | Print “Please Dim Light”; |
| | Set dot matrix to write display |
| | Delay (200) |
| } | |
| Set dot matrix rotation | |
| HEADER FILES | |
| Include −> if microcontroller is greater than or equal to 100 | |
| include microcontroller header file | |
| Else | |
| | Include wiring header files |
| End if | |
| If AVR_Atmel_tiny 85 | |
| | Include tinywire header file |
| Else | |
| | Include wire header file |
| End if | |
| Include Device_car Sticker header files | |
| Define 1 as LEDON | |
| Define 0 as LEDOFF | |
| Define 5 as LEDGREEN | |
| Define 3 as LEDYELLOW | |
| Define 1 as LEDRED | |
| Map 16x8 LEDcontroller driver | |
| Brightness −> 3; 1HZ−>2; 2HZ−>1 ; off−>O | |
| Display on −> Ox01; CMD−>Ox80 | |
| Make class Device1_Controller | |
| { | Make public |
| | Create function Device1_controller |
| | Call function for begin unassigned integer |
| | address |
| | Call function for blink rate |
| | Call function for write display |
| | Call function for clear |
| | Call function for brightness |
| | Make private argument of begin function |

}
Define function and pass in void
Define DEC10; HEX 16; OCT 8; BIN 2; BYTE 0
Call function to print characters, integers
Call function to print unsigned character

COMPUTER PROGRAM PSEUDOCODE LISTING 2

//Copyright 2015 Chukwudi Ihedinmah
Include libraries;
Define numbers of inputs for digitalread function
Define noise thresholds
Define the SetValue i.e. the value from 0 to 4096(This values
may change to reflect the most accurate values) that corresponds
to the point when out put switches from pseudoLow to pseudoHigh.
Define variables for modes of the switch2 and sensor
Define buffer for smile
int main( ){
//Initailizes GPIO
//Initialize DMA
//Initialize ADC
//define active sentenses
while(1)
{
//Calculate the mode of switch2
if (switchA==0 && switchB==1)
{

Set mode to OnA;

}
else if (switchA==1 && switchB==0)
{

Set mode to OnB;

}
else
{

Set mode to Off;
Clear Screen

}
Read input from the sensor

if(mode%2 !=0) //off mode

{

Clear Screen;

}

else

```
{
  if (mode==0)//OnA mode
  {
```

```
  if(sensor1==1) //sensor high
  {
```

```
Set sensor previous state to 1
  clear Screen
Print string1
delay;
Clear screen
Print string1
  delay;
```

```
  }
  else if (sensor_prev_state==1) //sensor is low but
```

previously it was high

{

Set sensor previous state to 0
Clear screen
print Smiley face;
delay
Clear screen
print String 3
delay;
Clear screen

}

```
  }
  else if (mode==2)//OnB mode
  {
```

```
  Clear screen
  Print String4
  delay
  Clear screen
  Print String 5
  Clear screen
  Clear screen
  Print String 6 With Shift
  delay
```

}

}

}
}
void clear(void)
{
//clears the screen
}
void printStringWithShift(char* s, int shift_speed, int b, int
cc, int size)// if shift_speed=0 thre is no shift)
{

while (*s != 0){

Read the input of the switch and sensor during printing of

the symbols

Calculate the mode of switch2

Check if, during execution, sensor or switch output

remains the same

Print Char
Go to the next symbol

}

}
void printSmile( )
{

Print smiley face

}
void digitalRead (int my_pin)
{
swinch(which pin to read)
perform data read from the necessary pin
Take into account noise when reading from analog pin
}

COMPUTER PROGRAM PSEUDOCODE LISTING 3

//All rights belong to Chukwudi Ihedinmah
Include libraries;
Define numbers of inputs for digitalread function
Define noise thresholds
Define the SetValue1 i.e. the value from 0 to 4096 that
corresponds to the point when out put switches from pseudoLow1
to pseudoHigh1
Define the SetValue2 i.e. the value from 0 to 4096 that
corresponds to the point when out put switches from pseudoLow2
to pseudoHigh2
Define variables for modes of the switch2 and both sensors
Define buffer for smile
int main( ){
//Initailizes GPIO
//Initialize DMA
//Initialize ADC for both sensors
//define active sentenses
while(1)
{
//Calculate the mode of switch2
if (switchA==0 && switchB==1)
{

Set mode to OnA;

}
else if (switchA==1 && switchB==0)
{

Set mode to OnB;

}
else
{

Set mode to Off;
Clear Screen

}
Read input from the sensor

if(mode%2!=0) //off mode

{

Clear Screen;

}

else

```
{
  if (mode==0)//OnA mode
  {
```

```
  if(sensor1==1) //sensor high
  {
```

```
Set sensor previous state to 1
  clear Screen
Print string1
delay;
Clear screen
Print string1
  delay;
```

```
  }
  else if (sensor_prev_state==1) //sensor is low but
```

previously it was high

{

Set sensor previous state to 0
Clear screen
print Smiley face;
delay
Clear screen
print String 3
delay;
Clear screen

}

```
  }
  else if (mode==2)//OnB mode
  {
```

```
  Clear screen
  Print String4
  delay
  Clear screen
  Print String 5
  Clear screen
  Clear screen
  Print String 6 With Shift
  delay
```

}

}

}
}
void clear(void)
{
//clears the screen
}
void printStringWithShift(char* s, int shift_speed, int b, int
cc, int size)// if shift_speed=0 thre is no shift)
{

while (*s != 0){

Read the input of the switch and sensor during printing of

the symbols

Calculate the mode of switch2

Check if, during execution, sensor or switch output

remains the same

Print Char
Go to the next symbol

}

}
void printSmile( )
{

Print smiley face

}
void digitalRead (int my_pin)
{
swinch(which pin to read)
perform data read from the necessary pin
//in case of analog read
{

```
  Take into account noise when reading from analog pins
  If (AnalogSensor1 is PseudoHigh1 && AnalogSensor2
```

is PseudoHigh2) TotalAnalogOutput is HIGH

Else TotalAnalogOutput is LOW

}
}

Therefore, the following is claimed:

1. In a motor vehicle, a system for requesting a driver of a vehicle behind another vehicle to dim his bright headlights comprising:
at least one digital message display mounted on the rear of a vehicle, said digital message display being adapted to display a digital message for requesting a driver who is operating a vehicle behind the requesting vehicle to dim his vehicle's bright headlights;
and a power supply for supplying electrical power to said digital message display.

2. The headlight dimming request system of claim 1 wherein said system is an automatic control system which is responsive to lights of high beam intensity from a vehicle behind the requesting vehicle.

3. The headlight dimming request system of claim 2 wherein said automatic control system comprises a photodiode unit which is responsive to lights of high beam intensity from a vehicle behind the requesting vehicle.

4. A digital message display for vehicles comprising:
a message display capable of displaying short textual messages, the message display being adapted for mounting in or on a first vehicle and thereby being viewable by a second vehicle behind;
at least one bright light sensor, the at least one bright light sensor being adapted for mounting in or on the first vehicle and thereby being subject to bright light incidence of the second vehicle;
a microcontroller in electrical communication with said message display and with said at least one bright light sensor; and
non-transitory computer readable media accessible to said microcontroller, the media storing microcontroller program instructions for determining bright light incidence on at least one bright light sensor and instructions for selectively displaying on said message display a predefined short textual message in response to the determination.

5. The digital message display for vehicles according to claim 4, wherein said message display comprises light emitting diodes or liquid crystals.

6. The vehicle with a digital message display according to claim 5, wherein said light emitting diodes or liquid crystals are arranged in a matrix.

7. The digital message display for vehicles according to claim 6, wherein said message comprises a request for the trailing driver to lower high beams.

8. The digital message display for vehicles according to claim 4 wherein the bright light sensor is disposed at a first end of a tube and a filter, a light control film, or a shader is disposed in the tube between the sensor and an aperture at a second end of the tube.

9. The digital message display for vehicles according to claim 4, further comprising a proximity detector; wherein the microcontroller program instructions for determining bright light incidence further comprise instructions to determine that a distance of the second vehicle from the first vehicle is within a set range as a condition for determining bright light incidence.

10. The digital message display of claim 4, further comprising a message selector configured to enable a user to select a particular message for display.

11. A motor vehicle comprising the display of claim 4.

12. The motor vehicle of claim 11, wherein the display is disposed inside the motor vehicle and visible through a rear window of the motor vehicle.

13. The motor vehicle of claim 11, wherein the display is integral to a rear body component of the motor vehicle.

14. The motor vehicle of claim 13, wherein the rear body component is selected from the group consisting of a truck lid, a spoiler, a bumper, and a substantially rear-facing surface.
